(19) United States
(12) Patent Application Publication
(10) Pub. No.: US 2025/0222347 A1
(43) Pub. Date: Jul. 10, 2025

(54) ROTATABLY-PRESSED DIRECTION KEY ASSEMBLY

(71) Applicant: Dongguan King Sheng Electronics Technology Co.,Ltd., Dongguan (CN)

(72) Inventor: Jianwu WANG, Dongguan (CN)

(21) Appl. No.: 19/092,924

(22) Filed: Mar. 27, 2025

(30) Foreign Application Priority Data
Oct. 18, 2024 (CN) 202422527195.7

(51) Int. Cl. A63F 13/24

(52) U.S. Cl. CPC A63F 13/24

(57) ABSTRACT

A rotatably-pressed direction key assembly, including a housing. A top of the housing is provided with a mounting portion and a plurality of through-holes. A direction key seat is provided within the housing, and includes a rotating portion and multiple pressing posts connected to the rotating portion. A pressing switch is provided within the housing below the pressing posts. A positioning part is provided within the housing. A top of the positioning part is connected to a positioning shaft. An upper portion of the positioning part is provided with a first arc surface. The rotating portion is provided with a second arc surface fitting the first arc surface. The rotating portion is further provided with a positioning hole extending vertically therethrough and fitting the positioning shaft.

### CROSS-REFERENCE TO RELATED APPLICATIONS

This application claims the benefit of priority from Chinese Patent Application No. 202422527195.7, filed on Oct. 18, 2024. The content of the aforementioned application, including any intervening amendments made thereto, is incorporated herein by reference in its entirety.

### TECHNICAL FIELD

This application relates to direction key assemblies, and more particularly to a rotatably-pressed direction key assembly.

### BACKGROUND

A game controller is a common component of electronic gaming devices, which controls simulated characters on electronic devices such as mobile phones and computers through manipulation of its buttons, thereby achieving gaming purposes. The game controller includes a controller housing, a direction key, a direction key mounting bracket, a plurality of elastic trigger buttons (e. g., silicone buttons or dome buttons) and a trigger circuit board (PCB). A center of the direction key is mounted on the direction key mounting bracket. The plurality of elastic trigger buttons are provided within the direction key mounting bracket. The trigger circuit board is provided within the controller housing below the direction key mounting bracket. By manipulating the direction key to press a specific trigger button, the trigger button moves toward the trigger circuit board, thereby contacting the trigger circuit board to trigger the corresponding function.

To enhance the operational flexibility of the direction key during pressing operations, some game controllers are designed with a rotatably-pressed direction key. For example, Chinese patent publication CN104383682B discloses a game controller, in which a limiting wing plate of a direction key (at a position corresponding to four cross-angles of the direction key) is provided with a first arc-shaped limiting structure. And an upper housing of a controller housing is provided with a second arc-shaped limiting structure fitting the first arc-shaped limiting structure. These structures maintain a uniform gap between the direction key and a wall of a mounting hole. When the direction key is pressed, it rotates along the arc-shaped path without deviation or misalignment, thereby significantly enhancing the consistency of operational tactile feedback.

However, during the pressing and rotating operation, a rotational structure fails to provide a downward limiting effect on the direction key, which may lead to excessive pressing and result in significant pressure being applied to the underlying press switch. This, in turn, accelerates the wear and tear of the press switch.

### SUMMARY

In view of this, an object of the disclosure is to provide a rotatably-pressed direction key assembly to overcome the defects in the prior art.

Technical solutions of the present disclosure are described as follows.

A rotatably-pressed direction key assembly, comprising:
a housing;
wherein a top of the housing is provided with a mounting portion and a plurality of through-holes; and the plurality of through-holes are configured to vertically run through the top of the housing and surround the mounting portion;
a direction key seat is provided within the housing; the direction key seat comprises a rotating portion corresponding to the mounting portion and a plurality of pressing posts respectively corresponding to the plurality of through-holes; the plurality of pressing posts are connected to the rotating portion; and a pressing switch is provided within the housing below the plurality of pressing posts;
a positioning part is provided within the housing; a top of the positioning part is connected to a positioning shaft; the positioning shaft is connected to the mounting portion, such that an accommodating space is formed between a bottom of the mounting portion and the positioning part for accommodating the rotating portion;
an upper portion of the positioning part is provided with a first arc surface, which is convex;
the rotating portion is provided with a second arc surface, which is concave and configured to fit the first arc surface;
the rotating portion is further provided with a positioning hole running vertically through the rotating portion, and the positioning hole is configured to fit the positioning shaft; and
the positioning hole is configured to allow the positioning shaft to pass through, with a limiting gap formed between a wall of the positioning hole and the positioning shaft.

In some embodiments, the mounting portion is provided with a connecting hole running vertically through of the mounting portion; and a top side of the positioning shaft is provided with a screw hole;
the rotatably-pressed direction key assembly further comprises a connecting screw; a rod portion of the connecting screw is configured to extend downward through the connecting hole to be threadedly connected with the screw hole; and a cap portion of the connecting screw is configured to abut against a top of the mounting portion to fix the positioning shaft to the mounting portion.

In some embodiments, the direction key seat further comprises an anti-deviation limiting part connected to the plurality of pressing posts;
an anti-deviation limiting wing extending downward is provided at a position within the housing adjacent to the plurality of through-holes;
a bottom of the anti-deviation limiting wing is provided with a guiding groove extending upward; and the guiding groove has a horizontal anti-deviation width corresponding to the anti-deviation limiting part.

In some embodiments, the horizontal anti-deviation width of the guiding groove is descending from bottom to top.

In some embodiments, a top wall of the guiding groove has a third arc surface; and a top of the anti-deviation limiting part has a fourth arc surface fitting the third arc surface.

In some embodiments, a bottom of the mounting portion is provided with a third arc surface, which is concave; and the rotating portion is provided with a fourth arc surface fitting the third arc surface.

In some embodiments, the anti-deviation limiting part is connected to a position of the plurality of pressing posts away from the rotating portion.

In some embodiments, the pressing switch is a pressing switch with an elastic reset function.

In some embodiments, a direction key cap is provided above the housing; and the direction key cap is connected to upper ends of the plurality of pressing posts through the plurality of through-holes.

In some embodiments, the number of the plurality of pressing posts is four; and the direction key cap has a cross-shaped structure corresponding to four pressing posts.

Compared to the prior art, the present disclosure has the following beneficial effects.

When the positioning part is connected to the mounting portion via the positioning shaft, the direction key seat can be correspondingly mounted. Through the cooperation between the first arc surface and the second arc surface, the direction key seat is enabled to be pressably rotatable. In this case, a rotational limit is formed by the cooperation between the wall of the positioning hole and the positioning shaft for connection, such that when a user presses any of the pressing posts, the direction key seat is configured to rotate downward to press the pressing switch below, thereby forming a downward stroke limitation. This design prevents excessive downward pressing, thereby avoiding damage to the pressing switch.

The technical solutions of the present disclosure will be described in further detail below with reference to the accompanying drawings and embodiments.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated in these drawings without making creative effort.

FIG. 1 is a front view of a rotatably-pressed direction key assembly according to an embodiment of the present disclosure;

FIG. 2 is a cross-sectional view of the rotatably-pressed direction key assembly along an A-A line in FIG. 1;

FIG. 3 is an exploded view of the rotatably-pressed direction key assembly according to an embodiment of the present disclosure;

FIG. 4 is a perspective view of a housing according to an embodiment of the present disclosure;

FIG. 5 is another cross-sectional view of the rotatably-pressed direction key assembly according to an embodiment of the present disclosure; and

FIG. 6 is another cross-sectional view of the rotatably-pressed direction key assembly according to an embodiment of the present disclosure.

In the figures: 1—housing; 2—mounting portion; 201—connecting hole; 202—third arc surface; 3—through-hole; 4—direction key seat; 401—rotating portion; 402—pressing post; 403—second arc surface; 404—positioning hole; 405—limiting gap; 406—anti-deviation limiting part; 407—fourth arc surface; 5—pressing switch; 6—positioning part; 601—first arc surface; 7—positioning shaft; 701—screw hole; 8—connecting screw; 9—anti-deviation limiting wing; 901—guiding groove; 10—direction key cap; and 11—silicone.

### DETAILED DESCRIPTION OF EMBODIMENTS

The present disclosure will be further clearly and completely described below with reference to the embodiments and accompanying drawings. Obviously, described herein are merely some embodiments of the present disclosure, rather than all embodiments. Based on the embodiments provided herein, all other embodiments obtained by those of ordinary skill in the art without making creative effort shall fall within the scope of the present disclosure.

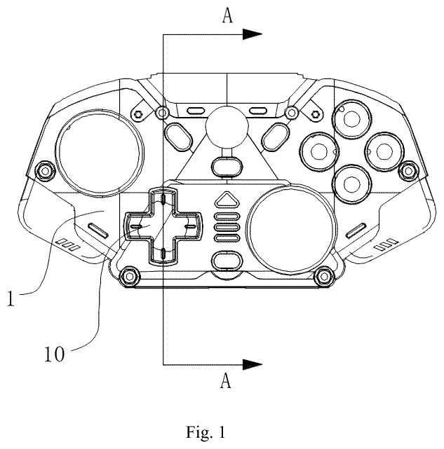

As shown in FIGS. 1-6, an embodiment of the present disclosure provides a rotatably-pressed direction key assembly, including a housing 1. A top of the housing 1 is provided with a mounting portion 2 and a plurality of through-holes 3. The plurality of through-holes 3 are configured to vertically run through the top of the housing 1 and surround the mounting portion 2.

A direction key seat 4 is provided within the housing 1. The direction key seat 4 includes a rotating portion 401 corresponding to the mounting portion 2 and a plurality of pressing posts 402 respectively corresponding to the plurality of the through-holes 3. The plurality of pressing posts 402 are connected to the rotating portion 401. A pressing switch 5 is provided within the housing 1 below the plurality of the pressing posts 402. An upper end of the pressing post 402 is configured to be pressed by a user through the plurality of through-hole 3. And a lower end of the pressing post 402 is configured as a triggering pressing head that cooperates with the corresponding pressing switch 5.

A positioning part 6 is provided within the housing 1. A top of the positioning part 6 is connected to a positioning shaft 7. The positioning shaft 7 is connected to the mounting portion 2, such that an accommodating space is formed between a bottom of the mounting portion 2 and the positioning part 6 for accommodating the rotating portion 401. An upper portion of the positioning part 6 is provided with a first arc surface 601, which is convex. The rotating portion 401 is provided with a second arc surface 403, which is concave and configured to fit the first arc surface 601.

The rotating portion 401 is further provided with a positioning hole 404 running vertically through the rotating portion, and the positioning hole is configured to fit the positioning shaft 7. The positioning hole 404 is configured to run through a position located on the second arc surface 403. The positioning hole 404 is configured to allow the positioning shaft 7 to pass through, with a limiting gap 405 formed between a wall of the positioning hole 404 and the positioning shaft 7.

When the positioning part 6 is connected to the mounting portion 2 via the positioning shaft 7, the direction key seat 4 can be correspondingly mounted. Through the cooperation between the first arc surface 601 and the second arc surface 403, the direction key seat 4 is enabled to be pressably rotatable. In this case, a rotational limit is formed by the cooperation between the wall of the positioning hole 404 and the positioning shaft 7 for connection, such that when a user presses any of the pressing posts, the direction key seat 4 is configured to rotate downward to press the pressing switch 5 below, thereby forming a downward stroke limitation. This design prevents excessive downward pressing, thereby avoiding damage to the pressing switch 5.

In some embodiments, the positioning shaft 7 is connected to the mounting portion 2 in the following manner. The mounting portion 2 is provided with a connecting hole 201 running vertically through of the mounting portion 2. And a top side of the positioning shaft 7 is provided with a screw hole 701. The rotatably-pressed direction key assembly provided herein further includes a connecting screw 8. A rod portion of the connecting screw 8 is configured to extend downward through the connecting hole 201 to be threadedly connected with the screw hole 701. And a cap portion of the connecting screw 8 is configured to abut against a top of the mounting portion 2 to fix the positioning shaft 7 to the mounting portion 2.

In this embodiment, a direction key cap 10 is provided above the housing 1. The direction key cap 10 is connected to upper ends of the plurality of pressing post 402 through the plurality of through-holes 3. For example, a bottom of the direction key cap 10 is provided with a plurality of slots corresponding to the upper ends of the pressing posts 402. The upper ends of the pressing posts 402 are configured to pass upward through the through-holes 3 to be engaged with the corresponding slot.

It should be noted that, an aperture of the through-hole 3 is at least sized such that, before the direction key seat 4 is rotatably pressed to trigger the pressing switch 5 below, the wall of the through-hole 3 does not obstruct the pressing post 402.

In this embodiment, the number of the plurality of pressing posts 402 is four. And the direction key cap 10 has a cross-shaped structure corresponding to four pressing posts 402.

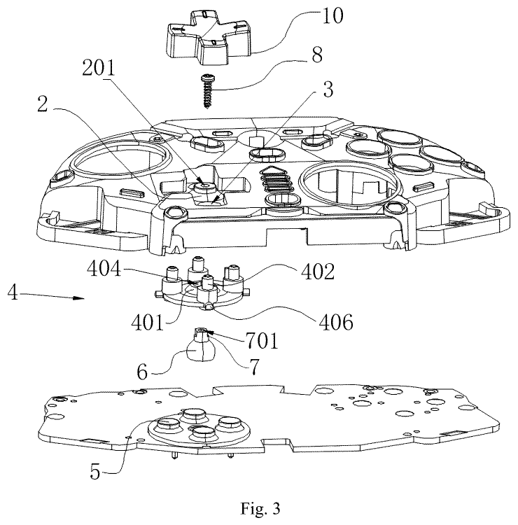

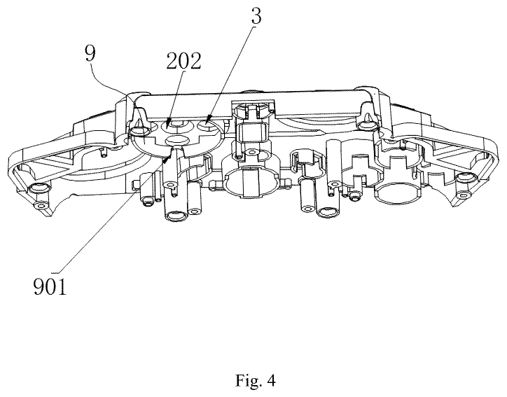

As shown in FIGS. 3-4, four through-holes 3 are arranged horizontally in a ring shape around the mounting portion 2.

In this embodiment, the direction key seat 4 further includes an anti-deviation limiting part 406 connected to the plurality of pressing posts 402. An anti-deviation limiting wing 9 extending downward is provided at a position within the housing 1 adjacent to the plurality of through-holes 3. A bottom of the anti-deviation limiting wing 9 is provided with a guiding groove 901 extending upward. The guiding groove 901 has a horizontal anti-deviation width corresponding to the anti-deviation limiting part 406. The guiding groove 901 is configured to cooperate with the anti-deviation limiting part 406 to provide vertical guidance, preventing the direction key seat 4 from undergoing horizontal deviation beyond a defined range.

In some embodiments, the horizontal anti-deviation width of the guiding groove 901 is descending from bottom to top.

In some embodiments, the anti-deviation limiting part 406 is connected to a position of the plurality of pressing posts 402 away from the rotating portion 401.

In some embodiments, a bottom of the mounting portion 2 is provided with a third arc surface 202, which is concave. The rotating portion 401 is provided with a fourth arc surface 407 fitting the third arc surface 202. During the rotatable pressing operation of the direction key seat 4, a portion of the second arc surface 403 of the rotating portion 401 is acted upon by the first arc surface 601 of the positioning part 6 during downward movement. Simultaneously, a portion of the fourth arc surface 407 of the rotating portion 401 is acted upon by the third arc surface 202 of the mounting portion 2 during upward movement. As a result, the rotating portion 401 is subjected to bidirectional forces, thereby improving the rotational performance during operation.

In some embodiments, the pressing switch 5 is a pressing switch with an elastic reset function, which can automatically reset after the user releases the pressure.

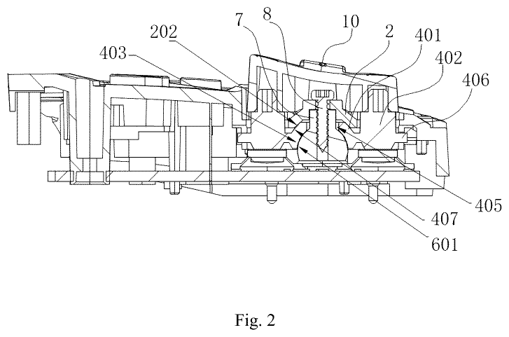

As shown in FIG. 2, in some embodiments, the pressing switch 5 can be a conductive silicone key.

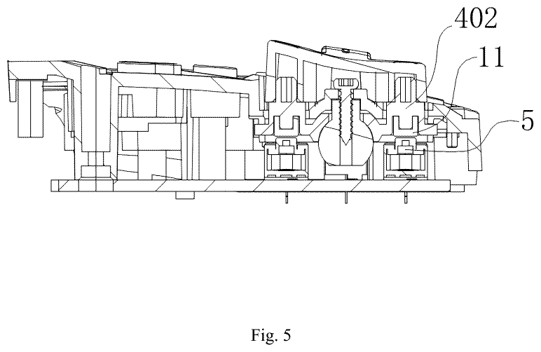

As shown in FIG. 5, in some embodiments, the pressing switch 5 can be a micro switch.

In some embodiments, the lower ends of the pressing posts 402 are further provided with a silicone sleeve corresponding to the pressing switch 5.

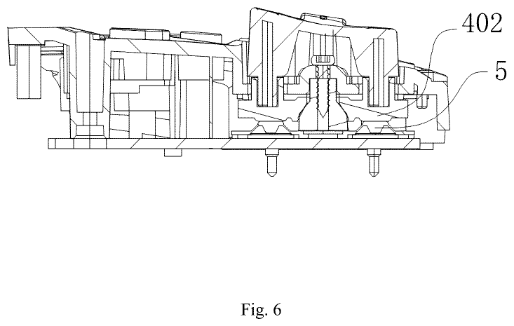

As shown in FIG. 6, in some embodiments, the pressing switch 5 can be a silicone button combined with a tactile switch or a dome switch.

In some embodiments, the direction key assembly provided herein can be provided on a game controller.

In some embodiments, when the direction key assembly provided herein is provided on the game controller, the housing 1 can be correspondingly connected to a housing of the game controller, or the housing 1 can be a part of the housing of the game controller.

It should be noted that the above embodiments are only used to illustrate the technical solutions of the present disclosure, rather than limiting the disclosure. Although the present disclosure has been described in detail with reference to the above embodiments, those of ordinary skill in the art could still make various modifications and substitutions to the technical solutions recited in the above embodiments. It should be understood that such modifications or substitutions made without departing from the spirit of the disclosure shall fall within the scope of the present disclosure defined by the appended claims.

What is claimed is:

1. A rotatably-pressed direction key assembly, comprising:
a housing;
wherein a top of the housing is provided with a mounting portion and a plurality of through-holes; and the plurality of through-holes are configured to vertically run through the top of the housing and surround the mounting portion;
a direction key seat is provided within the housing; the direction key seat comprises a rotating portion corresponding to the mounting portion and a plurality of pressing posts respectively corresponding to the plurality of through-holes; the plurality of pressing posts are connected to the rotating portion; and a pressing switch is provided within the housing below the plurality of pressing posts;
a positioning part is provided within the housing; a top of the positioning part is connected to a positioning shaft; the positioning shaft is connected to the mounting portion, such that an accommodating space is formed between a bottom of the mounting portion and the positioning part for accommodating the rotating portion;
an upper portion of the positioning part is provided with a first arc surface, which is convex;
the rotating portion is provided with a second arc surface, which is concave and configured to fit the first arc surface;
the rotating portion is further provided with a positioning hole running vertically through the rotating portion, and the positioning hole is configured to fit the positioning shaft; and
the positioning hole is configured to allow the positioning shaft to pass through, with a limiting gap formed between a wall of the positioning hole and the positioning shaft.

2. The rotatably-pressed direction key assembly of claim 1, wherein the mounting portion is provided with a connecting hole running vertically through of the mounting portion; and a top side of the positioning shaft is provided with a screw hole;
the rotatably-pressed direction key assembly further comprises a connecting screw; a rod portion of the connecting screw is configured to extend downward through the connecting hole to be threadedly connected with the screw hole; and a cap portion of the connecting screw is configured to abut against a top of the mounting portion to fix the positioning shaft to the mounting portion.

3. The rotatably-pressed direction key assembly of claim 1, wherein the direction key seat further comprises an anti-deviation limiting part connected to the plurality of pressing posts;
an anti-deviation limiting wing extending downward is provided at a position within the housing adjacent to the plurality of through-holes;
a bottom of the anti-deviation limiting wing is provided with a guiding groove extending upward; and the guiding groove has a horizontal anti-deviation width corresponding to the anti-deviation limiting part.

4. The rotatably-pressed direction key assembly of claim 3, wherein the horizontal anti-deviation width of the guiding groove is descending from bottom to top.

5. The rotatably-pressed direction key assembly of claim 3, wherein a top wall of the guiding groove has a third arc surface; and a top of the anti-deviation limiting part has a fourth arc surface fitting the third arc surface.

6. The rotatably-pressed direction key assembly of claim 3, wherein a bottom of the mounting portion is provided with a third arc surface, which is concave; and the rotating portion is provided with a fourth arc surface fitting the third arc surface.

7. The rotatably-pressed direction key assembly of claim 3, wherein the anti-deviation limiting part is connected to a position of the plurality of pressing posts away from the rotating portion.

8. The rotatably-pressed direction key assembly of claim 1, wherein the pressing switch is a pressing switch with an elastic reset function.

9. The rotatably-pressed direction key assembly of claim 1, wherein a direction key cap is provided above the housing; and the direction key cap is connected to upper ends of the plurality of pressing posts through the plurality of through-holes.

10. The rotatably-pressable direction key assembly of claim 9, wherein the number of the plurality of pressing posts is four; and the direction key cap has a cross-shaped structure corresponding to four pressing posts.
